(19) United States
(12) Patent Application Publication
(10) Pub. No.: US 2026/0255258 A1
(43) Pub. Date: Aug. 27, 2026

(54) METHOD FOR CONTROLLING SYSTEM INFORMATION DELIVERY

(71) Applicant: Nokia Technologies Oy, Espoo (FI)

(72) Inventors: Rafhael MEDEIROS DE AMORIM, Aalborg (DK); Mads LAURIDSEN, Gistrup (DK); Jeroen WIGARD, Klarup (DK); Daniela LASELVA, Klarup (DK)

(21) Appl. No.: 18/879,282

(22) PCT Filed: May 5, 2023
(86) PCT No.: PCT/EP2023/061975

§ 371 Date: Dec. 27, 2024

(30) Foreign Application Priority Data
Jun. 30, 2022 (FI) 20225612

(51) Int. Cl. H04W 48/12; H04W 68/00

(52) U.S. Cl. CPC H04W 48/12; H04W 68/005

(57) ABSTRACT

A method comprising: receiving from a network a message comprising a system information modification change indication and one or more subgroup specific indications; determining a subgroup the apparatus is associated with; and examining, based on the subgroup specific indication and the subgroup the apparatus is associated with, whether to invert the system information modification change indication. There is also disclosed a method comprising preparing to change one or more system information parameters of a network; examining which subgroups of user equipment are affected by the change; preparing, based on the examining, a message by including one or more indication whether the change of one or more system information parameters of the network is for user equipment of a subset of the subgroups or for user equipment irrespective of the subgroup; and sending the message.

### TECHNICAL FIELD

The present invention relates to controlling on-demand System information delivery.

### BACKGROUND

System information (SI) for user equipment (UE) in 4G/LTE and 5G NR networks comprises basic system information within a Master Information Block (MIB) broadcast on Physical Broadcast Channel (PBCH) periodically and various scheduling and cell access information within a set of System Information Blocks (SIBs) broadcast on Physical Downlink Shared Channel (PDSCH) also periodically.

In 3GPP networks, the System Information Blocks (SIBs) are blocks of information broadcasted by the network which contain system parameters that are required to be read by the UE in order to implement and interpret system-wide features and procedures for UEs in both RRC (radio resource control) idle (and inactive) and connected modes.

There are defined procedures for System Information (SI) updates, that allow for users to re-acquire the modified system information in due time to implement the modifications.

However, the network can only notify all UEs at once about modifications in the system information irrespective of the fact that the SI modification may affect only a subset of the UEs. This means that all UEs are required to re-read the SIB information blocks as dictated by the specification, even if the SI modification relates to a SIB for which the UE has no capability of. This is because the SI modification indication generally indicates that something is being changed but does not comprise information of what is being changed. However, in many cases the features being modified pertain to specific features. For example, such specific features may be UE power saving for an IoT device (Internet-of-Things), UAV aerial features (Unmanned Aerial Vehicle), Sidelink configuration, etc. Most UEs would not benefit to re-acquire the updated system information, as they cannot treat, use or even understand such features and because the main information in SIB1 would not change. For example: A NTN (non-terrestrial network) based UE needs to interpret information about satellite ephemeris, whereas V2X (vehicle to everything) UEs need to support PC5 type of communication, and other features related to road-to-vehicles communications (and many others).

Study on network energy savings for NR, may introduce more frequent SI modifications than before. For example, faster adaptations of the SSB period or Tx transmit power level may be expected. Therefore, the problem can be exacerbated in the future.

This problem may lead, not only to unnecessary consumption of power by the UEs, but it can also lead to unnecessary overhead for the physical interface resources or failures. If a UE receives a SIB modification update and fails to re-acquire SIB1 while T311 is running, the UE consider the cell as barred. If certain SIBs are not transmitted within the search space configured for the UE, the UE may request the RRC dedicated version of said SIBs. Also, if the concerned SI message was not received in the current modification period, handling of SI message acquisition is left to UE implementation, which may mean that the UE may request UE dedicated version of the SIBs via RRC messages or request on-demand transmissions of the SIBs.

### SUMMARY

Now, an improved method and technical equipment implementing the method has been invented, by which the above problems are alleviated. Various aspects include a method, an apparatus and a non-transitory computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to some embodiments the convention of the paging message is utilized for indicating system information modification and is backwards compatible with legacy UEs from previous releases of 3GGP TS 38.331. In accordance with an embodiment, one or more out of the spare bits in the short message are used to indicate which subgroups of UEs are affected by a SI modification indication carried in the short message. Any indicated subgroup of UEs then shall toggle the bit of the short message which indicates SI modification, and the UEs of a subgroup determine whether to re-acquire the SI content based on the outcome of the toggling operation (i.e. XOR operation).

The so-called subgroups may represent one of many subgroups:
of UEs assigned by the network,
of requested/supported features by the UE (that may be hardcoded in specs),
of subscription types (V2X, UAVs, etc),
of 3GPP releases supported by the UE
of PLMNs (public land mobile networks)
temporary indication via RRC for certain UEs.

As an example, if the information element indicating modification of SI (e.g. the first bit of the short message is equal to 1), the subgroups indicated (by their respective information element being 1) toggle the value of the information element indicating modification of SI to 0. The result is that the system information does not need to be acquired by this subgroup(s).

Likewise, if the first bit is equal to 0 (no modification in the SI), the subgroups assigned to the subsequent bits, toggle the information if their respective bit is 1. The result is that the UEs in the affected subgroups need to re-acquire the updated SI that concerns this subgroup(s) of users. For example, only selected SIBs may be required to be read by a given subgroup, based on network configuration or as defined in a standard.

The SIBs to be reacquired may be also pre-configured by network e.g. as part of the subgroup configurations.

According to a first aspect, there is provided an apparatus comprising means for receiving from a network a message comprising a system information modification change indication and one or more subgroup specific indications; means for determining a subgroup the apparatus is associated with; and means for examining, based on the subgroup specific indication and the subgroup the apparatus is associated with, whether to invert the system information modification change indication.

According to an embodiment, the apparatus comprises: means for examining the system information modification change indication; and means for using the system information modification change indication to determine whether to acquire at least one system information block from the network.

According to an embodiment, the apparatus comprises: means for adjusting a value of the system information modification change indication by inverting the value of the system information modification change indication, when the subgroup specific indication is set, or maintaining the value of the system information modification change indication when the subgroup specific indication is not set.

According to an embodiment, the apparatus comprises: means for determining, based on the system information modification change indication, whether to acquire from the network only one or more subgroup specific system information blocks, or one or more system information blocks, or all broadcasted system information blocks detected by the apparatus, or none of the system information blocks.

According to an embodiment, said means for determining are configured to determine whether to acquire from the network one or more system information blocks which are not subgroup specific.

According to an embodiment, said means for receiving a message are configured to receive the at least one of the system information modification change indication and one or more subgroup specific indications in a short message of a paging downlink control information.

According to an embodiment, the apparatus comprises: means for obtaining information regarding the subgroups and their assignment to the one or more subgroup specific indications and corresponding system information blocks.

According to an embodiment, the information regarding the subgroups and their assignment to the one or more subgroup specific indications is defined in a specification or assigned by the network.

According to an embodiment, the apparatus comprises: means for examining the system information modification change indication; and means for using the system information modification change indication to determine whether to acquire a system information block from the network.

According to a second aspect, there is provided an apparatus comprising: means for preparing to change one or more system information parameters of a network; means for examining which subgroups of user equipment are affected by the change; means for preparing, based on the examining, a message by including one or more indication whether the change of one or more system information parameters of the network is for user equipment of a subset of the subgroups or for user equipment irrespective of the subgroup; and means for sending the message.

According to an embodiment, the apparatus comprises means for preparing the message by setting a system information modification change indication and not setting any of one or more subgroup specific indications, when the change of the system information parameters affects all user equipment irrespective of the subgroup, or by not setting the system information modification change indication and setting the subgroup specific indication associated with the subgroup which is affected by the change of the system information parameters.

According to an embodiment, the message is a short message of a paging downlink control information.

According to an embodiment, the subgroups comprise one or more of the following:
UEs assigned by the network,
requested features by the UE,
supported features by the UE,
subscription types of the UE,
3GPP releases supported by the UE,
public land mobile networks,
temporary indication via an RRC for certain UEs.

According to an embodiment, the subscription type comprises one or more of the following:
Vehicle to everything,
Unmanned aerial vehicle.

A method according to a third aspect comprises: receiving from a network a message comprising a system information modification change indication and one or more subgroup specific indications; determining a subgroup the apparatus is associated with; and examining, based on the subgroup specific indication and the subgroup the apparatus is associated with, whether to invert the system information modification change indication.

A method according to a fourth aspect comprises: preparing to change one or more system information parameters of a network; means for examining which subgroups of user equipment are affected by the change; means for preparing, based on the examining, a message by including one or more indication whether the change of one or more system information parameters of the network is for user equipment of a subset of the subgroups or for user equipment irrespective of the subgroup; and means for sending the message.

According to a fifth aspect, there is provided an apparatus comprising at least one processor; and at least one memory including computer program code; the at least one memory and the computer program code configured to, with the at least one processor, to cause the apparatus to receive from a network a message comprising a system information modification change indication and one or more subgroup specific indications; determine a subgroup the apparatus is associated with; and examine, based on the subgroup specific indication and the subgroup the apparatus is associated with, whether to invert the system information modification change indication.

According to an embodiment, said at least one memory includes computer program code; the at least one memory and the computer program code configured to, with the at least one processor, to cause the apparatus to determine whether to acquire from the network one or more system information blocks which are not subgroup specific.

According to an embodiment, said at least one memory includes computer program code; the at least one memory and the computer program code configured to, with the at least one processor, to cause the apparatus to receive the at least one of the system information modification change indication and one or more subgroup specific indications in a short message of a paging downlink control information.

According to an embodiment, said at least one memory includes computer program code; the at least one memory and the computer program code configured to, with the at least one processor, to cause the apparatus to obtain information regarding the subgroups and their assignment to the one or more subgroup specific indications and corresponding system information blocks.

According to an embodiment, said at least one memory includes computer program code; the at least one memory and the computer program code configured to, with the at least one processor, to cause the apparatus to examine the system information modification change indication; and means for using the system information modification change indication to determine whether to acquire a system information block from the network.

According to a sixth aspect, there is provided an apparatus comprising at least one processor; and at least one memory including computer program code; the at least one memory and the computer program code configured to, with the at least one processor, to cause the apparatus to prepare to change one or more system information parameters of a network; examine which subgroups of user equipment are affected by the change; prepare, based on the examining, a message by including one or more indication whether the change of one or more system information parameters of the network is for user equipment of a subset of the subgroups or for user equipment irrespective of the subgroup; and send the message.

According to an embodiment, said at least one memory includes computer program code; the at least one memory and the computer program code configured to, with the at least one processor, to cause the apparatus to prepare the message by setting a system information modification change indication and not setting any of one or more subgroup specific indications, when the change of the system information parameters affects all user equipment irrespective of the subgroup, or by not setting the system information modification change indication and setting the subgroup specific indication associated with the subgroup which is affected by the change of the system information parameters.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIG. 1 shows a schematic block diagram of an apparatus for incorporating functionalities for implementing various embodiments;

FIG. 2 shows schematically a layout of an apparatus according to an example embodiment;

FIG. 3 shows a part of an exemplifying radio access network;

FIG. 4 shows an example of a modification of SI information using modification periods, in accordance with an approach of the disclosure;

FIG. 5 shows a flow chart for a method for determining whether to acquire a SIB for updating signalling information according to an embodiment; and

FIG. 6 shows a signalling chart between the network and two UEs in different subgroups for SI update according to an embodiment;

FIG. 7 shows a method for a network element according to an embodiment.

### DETAILED DESCRIPTION OF SOME EXAMPLE EMBODIMENTS

The following describes in further detail suitable apparatus and possible mechanisms carrying out the operations for controlling on-demand System information delivery. While the following focuses on 5G networks, the embodiments as described further below are by no means limited to be implemented in said networks only, but they are applicable in any network and protocol entities supporting on-demand System information delivery.

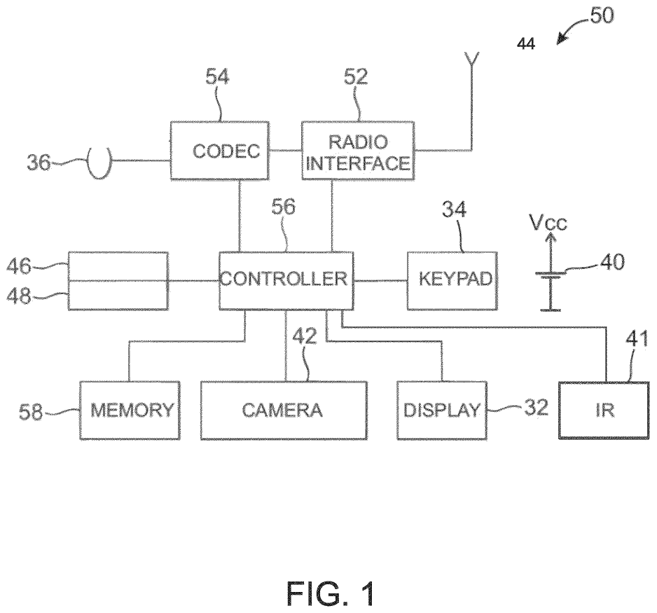

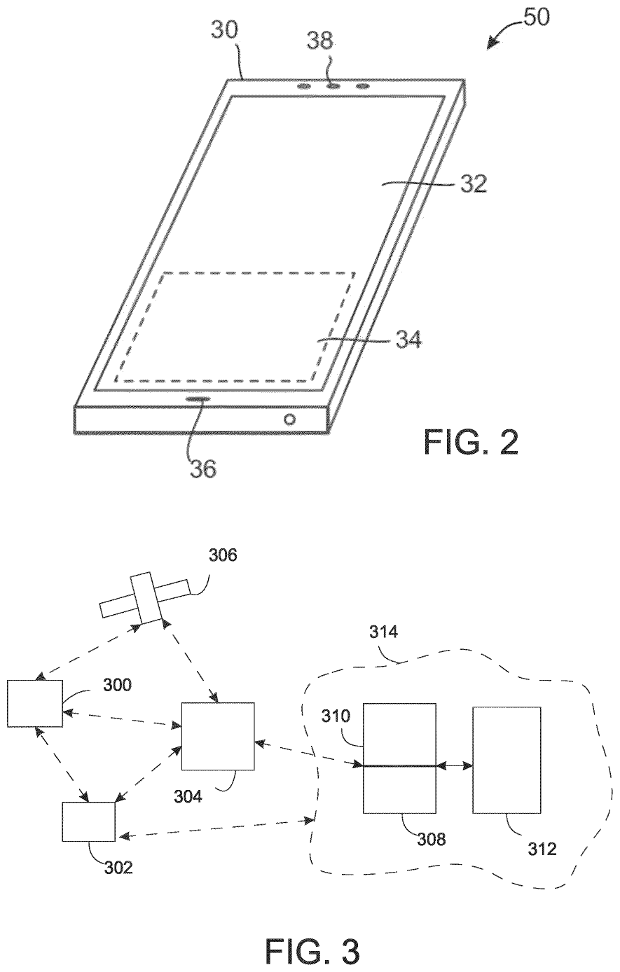

In this regard, reference is first made to FIGS. 1 and 2, where FIG. 1 shows a schematic block diagram of an exemplary apparatus or electronic device 50, which may incorporate the arrangement according to the embodiments. FIG. 2 shows a layout of an apparatus according to an example embodiment. The elements of FIGS. 1 and 2 will be explained next.

The electronic device 50 may, for example, be a mobile terminal or user equipment of a wireless communication system. The apparatus 50 may comprise a housing 30 for incorporating and protecting the device. The apparatus 50 further may comprise a display 32 and a keypad 34. Instead of the keypad, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device, such as anyone of: an earpiece 38, speaker, or an analogue audio or digital audio output connection. The apparatus 50 may also comprise a battery 40 (or the device may be powered by any suitable mobile energy device such as solar cell, fuel cell or clockwork generator). The apparatus may further comprise a camera 42 capable of recording or capturing images and/or video. The apparatus 50 may further comprise an infrared port 41 for short range line of sight communication to other devices. In other embodiments the apparatus 50 may further comprise any suitable short-range communication solution such as for example a Bluetooth wireless connection or a USB/firewire wired connection.

The apparatus 50 may comprise a controller 56 or processor for controlling the apparatus 50. The controller 56 may be connected to memory 58 which may store both user data and instructions for implementation on the controller 56. The memory may be random access memory (RAM) and/or read only memory (ROM). The memory may store computer-readable, computer-executable software including instructions that, when executed, cause the controller/processor to perform various functions described herein. In some cases, the software may not be directly executable by the processor but may cause a computer (e.g., when compiled and executed) to perform functions described herein. The controller 56 may further be connected to codec circuitry 54 suitable for carrying out coding and decoding of audio and/or video data or assisting in coding and decoding carried out by the controller.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In the following, different exemplifying embodiments will be described using, as an example of an access architecture to which the embodiments may be applied, a radio access architecture based on Long Term Evolution Advanced (LTE Advanced, LTE-A) or new radio (NR, 5G), without restricting the embodiments to such an architecture, however. A person skilled in the art appreciates that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof.

FIG. 3 depicts examples of simplified system architectures only showing some elements and functional entities, all being logical units, whose implementation may differ from what is shown. The connections shown in FIG. 3 are logical connections; the actual physical connections may be different. It is apparent to a person skilled in the art that the system typically comprises also other functions and structures than those shown in FIG. 3. The embodiments are not, however, restricted to the system given as an example but a person skilled in the art may apply the solution to other communication systems provided with necessary properties.

The example of FIG. 3 shows a part of an exemplifying radio access network.

FIG. 3 shows user devices 300 and 302 configured to be in a wireless connection on one or more communication channels in a cell with an access node (such as (e/g) NodeB) 304 providing the cell. The physical link from a user device to a (e/g) NodeB is called uplink or reverse link and the physical link from the (e/g) NodeB to the user device is called downlink or forward link. It should be appreciated that (e/g) NodeBs or their functionalities may be implemented by using any node (such as Integrated Access and Backhaul (IAB) node), host, server or access point etc. entity suitable for such a usage.

A communication system typically comprises more than one (e/g) NodeB in which case the (e/g) NodeBs may also be configured to communicate with one another over links, wired or wireless, designed for the purpose. These links may be used for signaling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to user devices. The antenna unit may comprise a plurality of antennas or antenna elements. The (e/g) NodeB is further connected to core network 310 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The CN may comprise network entities or nodes that may be referred to management entities. Examples of the network entities comprise at least an Access and Mobility Management Function (AMF).

In 5G NR, the User Plane Function (UPF) may be used to separate the control plane and the user plane functions. Therein, the Packet Gateway (PGW) control and user plane functions may be decoupled, whereby the data forwarding component (PGW-U) may be decentralized, while the PGW-related signaling (PGW-C) remains in the core. This allows packet processing and traffic aggregation to be performed closer to the network edge, increasing bandwidth efficiencies while reducing network.

The user device (also called a user equipment (UE), a user terminal, a terminal device, a wireless device, a mobile station (MS) etc.) illustrates one type of an apparatus to which resources on the air interface are allocated and assigned, and thus any feature described herein with a user device may be implemented with a corresponding network apparatus, such as a relay node, an eNB, and an gNB. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. Accordingly, the user device may be an IoT-device. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. The access nodes of the radio network form transmission/reception (TX/Rx) points (TRPs), and the UEs are expected to access networks of at least partly overlapping multi-TRPs, such as macro-cells, small cells, pico-cells, femto-cells, remote radio heads, relay nodes, etc. The access nodes may be provided with Massive MIMO antennas, i.e. very large antenna array consisting of e.g. hundreds of antenna elements, implemented in a single antenna panel or in a plurality of antenna panels, capable of using a plurality of simultaneous radio beams for communication with the UE. The UEs may be provided with MIMO antennas having an antenna array consisting of e.g. dozens of antenna elements, implemented in a single antenna panel or in a plurality of antenna panels. Thus, the UE may access one TRP using one beam, one TRP using a plurality of beams, a plurality of TRPs using one (common) beam or a plurality of TRPs using a plurality of beams.

The 4G/LTE networks support some multi-TRP schemes, but in 5G NR the multi-TRP features are enhanced e.g. via transmission of multiple control signals via multi-TRPs, which enables to improve link diversity gain. Moreover, high carrier frequencies (e.g., mmWaves) together with the Massive MIMO antennas require new beam management procedures for multi-TRP technology.

5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Frequency bands for 5G NR are separated into two frequency ranges: Frequency Range 1 (FR1) including sub-6 GHz frequency bands, i.e. bands traditionally used by previous standards, but also new bands extended to cover potential new spectrum offerings from 410 MHz to 7125 MHz, and Frequency Range 2 (FR2) including frequency bands from 24.25 GHz to 52.6 GHz. Thus, FR2 includes the bands in the mmWave range, which due to their shorter range and higher available bandwidth require somewhat different approach in radio resource management compared to bands in the FR1.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 312, or utilize services provided by them. The communication network may also be able to support the usage of cloud services, for example at least part of core network operations may be carried out as a cloud service (this is depicted in FIG. 3 by “cloud” 314). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU) and non-real time functions being carried out in a centralized manner (in a centralized unit, CU 308).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well. The gNB is a next generation Node B (or, new Node B) supporting the 5G network (i.e., the NR).

5G may also utilize non-terrestrial nodes 306, e.g. access nodes, to enhance or complement the coverage of 5G service, for example by providing backhauling, wireless access to wireless devices, service continuity for machine-to-machine (M2M) communication, service continuity for Internet of Things (IoT) devices, service continuity for passengers on board of vehicles, ensuring service availability for critical communications and/or ensuring service availability for future railway/maritime/aeronautical communications. The non-terrestrial nodes may have fixed positions with respect to the Earth surface or the non-terrestrial nodes may be mobile non-terrestrial nodes that may move with respect to the Earth surface. The non-terrestrial nodes may comprise satellites and/or HAPSs. Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node 304 or by a gNB located on-ground or in a satellite.

It should also be noted that the gNB 304 can be on board of the non-terrestial nodes 306 (regenerative architecture) or can be on the ground (transparent architecture).

A person skilled in the art appreciates that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 1). A HNB Gateway (HNB-GW), which is typically installed within an operator's network may aggregate traffic from a large number of HNBs back to a core network.

The Radio Resource Control (RRC) protocol is used in various wireless communication systems for defining the air interface between the UE and a base station, such as eNB/gNB. This protocol is specified by 3GPP in in TS 36.331 for LTE and in TS 38.331 for 5G. In terms of the RRC, the UE may operate in LTE and in 5G in an idle mode or in a connected mode, wherein the radio resources available for the UE are dependent on the mode where the UE at present resides. In 5G, the UE may also operate in inactive mode. In the RRC idle mode, the UE has no connection for communication, but the UE is able to listen to paging messages. In the RRC connected mode, the UE may operate in different states, such as CELL_DCH (Dedicated Channel), CELL_FACH (Forward Access Channel), CELL_PCH (Cell Paging Channel) and URA_PCH (URA Paging Channel). The UE may communicate with the eNB/gNB via various logical channels like Broadcast Control Channel (BCCH), Paging Control Channel (PCCH), Common Control Channel (CCCH), Dedicated Control Channel (DCCH), Dedicated Traffic Channel (DTCH).

The actual user and control data from network to the UEs is transmitted via downlink physical channels, which in 5G include Physical downlink control channel (PDCCH) which carries the necessary downlink control information (DCI), Physical Downlink Shared Channel (PDSCH), which carries the user data and system information for user, and Physical Broadcast Channel (PBCH), which carries the necessary system information to enable a UE to access the 5G network.

The user and control data from UE to the network is transmitted via uplink physical channels, which in 5G include Physical Uplink Control Channel (PUCCH), which is used for uplink control information including HARQ feedback acknowledgments, scheduling request, and downlink channel-state information for link adaptation, Physical Uplink Shared Channel (PUSCH), which is used for uplink data transmission, and Physical Random Access Channel (PRACH), which is used by the UE to request connection setup referred to as random access.

The transitions between the states are controlled by a state machine of the RRC. When the UE is powered up, it is in a Disconnected mode/Idle mode. The UE may transit to RRC Connected mode with an initial attach or with a connection establishment. If there is no activity from the UE for a short time, eNB/gNB may suspend its session by moving the UE to RRC Inactive mode and can resume its session by moving to RRC Connected mode. The UE can move to the RRC Idle mode from the RRC Connected mode or from the RRC Inactive mode.

When the UE is in RRC Connected mode, it must periodically perform beam management related operations, such as tracking reference signal/channel state information reference signals (TRS/CSI-RS) measurements, synchronization signal blocks (SSB) measurements, as well as to report periodically the result of these measurements to the network.

When the UE is in RRC Idle/Inactive mode and it is controlled to transfer to RRC Connected mode, it must acquire System Information (SI) to access the network. The System information (SI) for UEs comprises the Master Information Block (MIB) and a set of System Information Blocks (SIBs). The MIB comprises the basic system information and it is broadcast on PBCH periodically. The SIBs, in turn, comprise various scheduling and cell access information broadcast on PDSCH.

The 5G NR system introduces a new approach for SI transmission called on-demand SI delivery. In NR, MIB and SIB1 are defined as minimum SI while the other SIBs (SIB2, SIB3, . . . ) are defined as other SI. Minimum SI provides the basic information on acquiring other SI and processing initial access. Minimum SI is broadcast periodically in the SI window, and the UEs monitor the SI window of the broadcast period for obtaining the SI.

The other SI comprises additional information and may be delivered when needed, i.e. as on-demand basis. When the UE sends an on-demand SIB request, it keeps monitoring the SI windows of the broadcast period to receive the SIB. The access node, such as an eNB or a gNB, broadcasts the requested SIB in the SI window when it receives the SIB request.

The network can also choose to schedule the other SI in the SI window even if it has not received a request from a UE.

For providing the UEs in RRC Idle/Inactive mode with more synchronization opportunities to transfer to RRC Connected mode, as well as to monitor for paging, a specific SIB could be used to broadcast TRS/CSI-RS configurations for UEs in RRC Idle/Inactive mode. This is feasible because the network may already be transmitting such reference signals to the RRC Connected UEs. Instead of broadcasting such a rather large SIB periodically without exact information if there is any RRC Idle/Inactive UEs in need of the TRS/CSI-RS configurations, it is more preferable to deliver the information as on-demand SIB.

In the current 3GPP specification, more precisely in TS38.331 Rel-16, the UE is required to start a timer, when requesting one or more on-demand SIBs. In TS38.331, this timer is referred to as T350. Thereafter, the UE is only allowed to request the SIB again when the timer T350 is not running (i.e., it is expired or otherwise stopped).

Provided that the timer is not running, the UE may request on-demand SIBs with reference signal information, such as TRS/CSI-RS information, rather frequently, for example as a default operation. However, a SIB with reference signal information may be assumed to be rather large and too frequent on-demand SIB requests may lead to unnecessarily large signalling overhead.

In 5G NR, the specifications for modifications in the SI are described in TS 38.331, Section 5.2.2.2. The specification divides the timeline of the gNB in “modification periods”. If the gNB transmits a “SI change indication” within a modification period, the updated version of the affected SIs is transmitted in the modification period subsequent to this one. In other words, there are segments in time (boundaries of the modification periods) that define the periods during which SIs can be updated.

The modification period boundary is defined by SFN (system frame numbers) values for which SFN mod m=0, where m is the number of radio frames comprising the modification period i.e. m=modificationPeriodCoeff*defaultPagingCycle, and mod is the modulo operation. The modification period coefficient can be 2, 4, 8 and 16, whereas the defaultPagingCycle window may be 32, 64, 128 or 256 radio frames. Therefore, the modification period may vary between 64 and 4096 radio frames (640 ms to 40.960 s).

The UE receives indication about SI modifications and/or PWS notifications via the Short Message scrambled with P-RNTI over a DCI (DL control information). The short message format is provided in Table 6.5-1 in TS 38.331, which is described in Table 1 below.

TABLE 1

| Bit | Short Message |
|---|---|
| 1 | systemInfoModification |
| | If set to 1: indication of a BCCH modification other than SIB6, SIB7 |
| | and SI |
| 2 | etwsAndCmasIndication |
| | If set to 1: indication of an ETWS primary notification and/or an |
| | ETWS secondary notification and/or a CMAS notification |
| 3 | stopPagingMonitoring |
| | If set to 1: stop monitoring PDCCH occasions(s) for paging in this |
| | Paging Occasion. |
| 4-8 | 4-8 Not used in this release of the specification, and shall be ignored |
| | by UE if received |

It should be observed that whereas modification of any regular SIB is indicated in the first bit (bit 1), the inclusion of emergency SIBs used for Earthquake and Tsunami warning system (ETWS) and/or Commercial Mobile Alert System (CMAS) in the next modification period is indicated separately.

The stopPagingMonitoring information element indicates whether to continue or stop monitoring PDCCH occasions(s) for paging in this Paging Occasion.

The behavior of the UE upon receiving a short message with indication of SI modification in the next modification period is specified as such in TS 38.331:

If the UE receives a Short Message, the UE may perform the following.

If the UE is ETWS capable or CMAS capable, and the etwsAndCmasIndication bit of the Short Message is set (bit 2), and the UE is provided with searchSpaceSIB1 and the information element searchSpaceOtherSystemInformation is present on the active bandwidth part (BWP) or the initial BWP, the UE immediately re-acquires the SIB1.

If the UE is ETWS capable and the information element SI-SchedulingInfo includes scheduling information for SIB6, the UE acquires SIB6 substantially immediately.

If the UE is ETWS capable and the information element SI-SchedulingInfo includes scheduling information for SIB7, the UE acquires SIB7 substantially immediately.

If the UE is CMAS capable and the information element SI-SchedulingInfo includes scheduling information for SIB8, the UE acquires SIB8 substantially immediately.

If the systemInfoModification bit of the Short Message is set, the UE applies the SI acquisition procedure as defined in sub-clause 5.2.2.3 from the start of the next modification period.

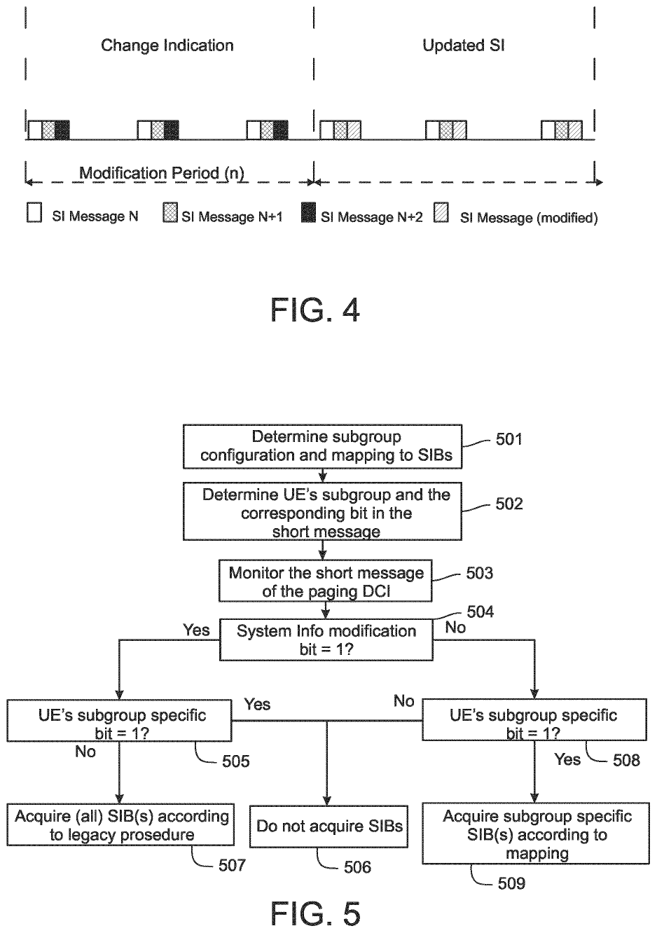

The modification has first to be notified in one modification period via a Short Message transmitted via paging, and then modified on the next modification period, as depicted in FIG. 4.

In the following, an example of utilization of the short message in informing certain UE groups whether to re-acquire SI content or not will be described, in accordance with an embodiment.

Table 2 below shows the short message format in which one or more of those spare bits will be utilized in the method. The short message comprises at least the systemInfoModification information element indicative of modification of the SI, etwsAndCmasIndication information element, stopPagingMonitoring information element, and several groupIndication information elements indicative of which group or groups, if any, the short message is addressed to, as will be described below.

In accordance with an embodiment, each of the information elements is one bit and may have the value 0 or 1.

TABLE 2

| Bit | Short Message |
|---|---|
| 1 | systemInfoModification |
| | If set to 1: indication of a BCCH modification other than SIB6, SIB7 |
| | and SI |
| 2 | etwsAndCmasIndication |
| | If set to 1: indication of an ETWS primary notification and/or an |
| | ETWS secondary notification and/or a CMAS notification |
| 3 | Subgroup 1 |
| | If set to 1, UEs belonging to Subgroup 1 should toggle the |
| | systemInfoModification information element |
| 4 | Subgroup 2 |
| | If set to 1, UEs belonging to Subgroup 2 should toggle the |
| | systemInfoModification information element |
| 5 | Subgroup 3 |
| | If set to 1, UEs belonging to Subgroup 3 should toggle the |
| | systemInfoModification information element |
| 6 | Subgroup 4 |
| | If set to 1, UEs belonging to Subgroup 4 should toggle the |
| | systemInfoModification information element |
| 7 | N/A |
| 8 | N/A |

There are currently several segmentations of UEs and scenarios, and not all UE capabilities are necessary present/turned on in all implementations. There are also several subgroups of such segmentations in the current specifications, which comprehend (but are not limited to) the following examples:
NTN: Non-terrestial network
V2X: Vehicle to everything
Drones/UAVs. Uncrewed/unmanned aerial vehicles
HAPS: High altitude platform system
URLLC: Ultra-reliable low latency communication
RedCap/NR Light: Reduced capability
Sidelink
Network Slicing
Subscription based features
Positioning

The so-called subgroups may also represent one of many subgroups:
of UEs assigned by the network,
of requested/supported features by the UE (that may be hardcoded in specs),
of subscription types (V2X, UAVs, etc),
of 3GPP releases supported by the UE
of PLMNs
temporary indication via RRC for certain UEs.

The UEs may be associated with one or more of such subgroups based on the type of the UE.

It should be noted that the subgroups can be area specific, such that it can be optimised per area. Furthermore, the list above is only an example of possible subgrouping and also other kinds of subgroups may be defined or only a portion of the above mentioned subgroups may be used in different implementations.

In the following, an example will be provided in which the following subgroups are assigned by a gNB and the short messages according to Table 2 are used:
Subgroup 1—UAVs
Subgroup 2—3GGP TS 38.331 Rel 18 NR Features for Network Energy Saving
Subgroup 3—Sidelink Capable UEs
Subgroup 4—3GGP TS 38.331 Rel. 19 V2X Features Capable UEs

As can be seen from Table 2, each group above is mapped into one spare bit in the short message (e.g. Group 1 into Bit3, Group 2 into bit4, Group 3 into bit 5, and Group 4 into bit 6, where spare bits 7 and 8 are still left for future use).

The following examples different Short Message contents, presented in Table 3, illustrates an embodiment. The structure of the short message is similar to the structure presented in Table 2, wherein the information elements are only referred as bits 1 to 8, i.e. Bit 1 is the SI modification, Bit 2 is the ETWS/CMAS indication, etc.

TABLE 3

| | Bit 1 | Bit 2 | Bit 3 | Bit 4 | Bit 5 | Bit 6 | Bit 7 | Bit 8 |
|---|---|---|---|---|---|---|---|---|
| Ex. 1 | 1 | x | 0 | 1 | 0 | 0 | x | x |
| Ex. 2 | 0 | x | 1 | 0 | 0 | 0 | x | x |
| Ex. 3 | 0 | x | 1 | 0 | 0 | 1 | x | x |

In the example 1 (Ex. 1), all users, including legacy users, receive the indication that the System Information has been modified (Bit 1 is set to 1) and they need to acquire the new information. However, the UEs in the group identified by Bit 4 (Group 2, Rel 18 NR Features for Energy Saving), shall toggle the content of Bit 1, because the value of the Bit 4 is one, which means that the value of the Bit 1 would be seen by the UEs in this group as 0 (=Bit 1 XOR Bit 4, in which XOR is a binary operation between two operands A & B and the result of the binary operation is logical 0 when both the operands have the same value, i.e. A=0 & B=0 or A=1 & B=1, and 1 otherwise, i.e. A=0 & B=1 or A=1 & B=0). Therefore, those UEs belonging to Group 2 shall not re-acquire the SIBs. This can be used, for example, if these users have already been notified about a gradual ramp down of the cell, and don't need to update their understanding of transmit power. It should be noted that the UEs in the other group will acquire the SI, because their group-specific bits do not indicate to toggle the SI modification bit i.e. Bit 1 XOR Bit 3=0, Bit 1 XOR Bit 5=0, Bit 1 XOR Bit 6=0.

In the example 2, the first bit is 0, indicating no modifications in the SI. However, specifically for UEs in Group 1 (UAVs) the bit 3 indicates that they should toggle the first bit, which means that there is an update in the aerial features indicated in the SIB, and therefore these users should re-read the SIB.

In the example 3, the scenario is very similar to the one described in scenario of the example 2, except that multiple groups are indicated (Bits 3 and 6), wherein UEs belonging either to Group 1 or Group 4 should toggle the value of the Bit 1. The features being modified may correspond to several groups and thus the UEs of the respective groups may read different SIBs.

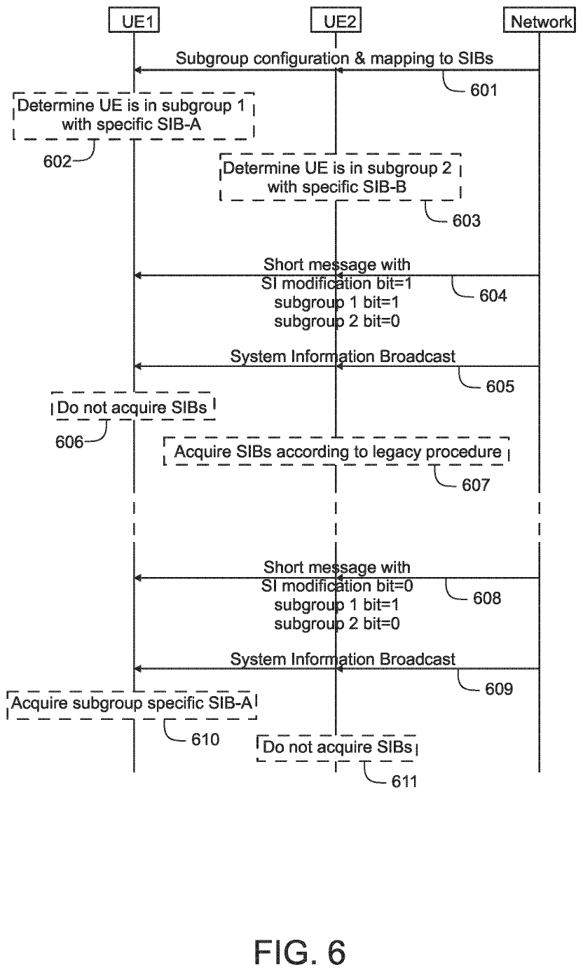

In the following, a method for a UE to decide whether or not to acquire a SIB to update SI based on the content of the short message will be described with reference to the flow diagram of FIG. 5. FIG. 6 illustrates the corresponding signaling diagram between the network and two UEs in different subgroups. The method will be explained with reference to one UE but similar procedures may be applied by other UEs as well, in the example signalling diagram such UEs are a first UE1 and a second UE2.

A network element, e.g. a gNB, sends (601) a subgroup configuration and mapping to SIBs so that UEs served by the gNB may receive the messages. The UE receives the message and determines (block 501) the subgroup configuration and mapping to SIBs. The UE also determines (502 in FIG. 5 and block 602 in FIG. 6) the subgroup the UE belongs to and the corresponding information element in the short message i.e. the bit in the short message which is reserved for that subgroup. In the example of FIG. 6 the first UE1 determines 602 that it belongs to the subgroup 1 with a specific SIB-A. Correspondingly, the second UE2 determines 603 that it belongs to the subgroup 2 with a specific SIB-B.

In accordance with an approach, UEs in RRC_IDLE or in RRC_INACTIVE shall monitor for SI change indication in its own paging occasion every DRX cycle. UEs in RRC_CONNECTED shall monitor for SI change indication in any paging occasion at least once per modification period if the UE is provided with common search space on the active BWP to monitor paging. The UE monitors 503 the short message of the paging downlink control information (DCI). When the UE receives the short message the UE decodes the content of the short message and examines 504 the system information modification information element (Bit 1). If the information element indicates that the system information is modified (e.g. bit 1=1), the UE also examines 505 the value of the subgroup specific bit related to that subgroup the UE belongs to (e.g. bit x, where x is 3, 4, 5 or 6 in this example). If the value of that information element indicates (bit x=1) that the value of the system information modification information element should be toggled, the UE does not acquire 506 SIBs (1 XOR 1=0). On the other hand, if the value of that information element indicates (bit x=0) that the value of the system information modification information element should not be toggled, the UE acquires 507 SIBs (1 XOR 0=1) according to a legacy procedure.

If the examination in step 504 reveals that the system information modification information element indicates that the system information is not modified (e.g. bit 1=0), the UE examines 508 the value of the subgroup specific bit related to that subgroup the UE belongs to (e.g. bit x, where x is 3, 4, 5 or 6 in this example). If the value of that information element indicates (bit x=1) that the value of the system information modification information element should be toggled, the UE acquires 509 subgroup specific SIBs (0 XOR 1=1). On the other hand, if the value of that information element indicates (bit x=0) that the value of the system information modification information element should not be toggled, the UE does not acquire SIBs (0 XOR 0=0).

In the exemplified signalling diagram of FIG. 6 the network element sends 604 the short message having the SI modification bit set (=1), the subgroup 1 bit set, and the subgroup 2 bit not set (=0). Therefore, when the network element performs 605 system information broadcast, the first UE1 does not acquire 606 SIBs, but the second UE2 acquires 607 SIBs according to a legacy procedure.

The signalling diagram also depicts an example of a situation in which the network element sends 608 the short message having the SI modification bit not set (=0), the subgroup 1 bit set, and the subgroup 2 bit not set (=0). Therefore, when the network element performs 609 system information broadcast, the first UE1 acquires 610 subgroup specific SIBs, but the second UE2 does not acquire 611 SIBs.

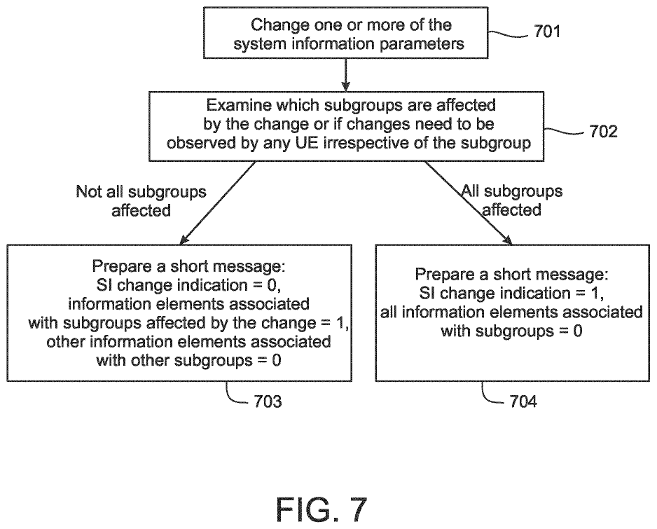

In the following, a method for a network element will be described with reference to the flow diagram of FIG. 7, in accordance with an embodiment.

The network element may be, for example, the gNB. When the network changes 701 one or more of the system information parameters, the network element examines 702 which subgroups are affected by the change or if changes need to be observed by any UE irrespective of the subgroup. If it is determined that the changes affect only one subgroup or some but not all subgroups, the network element prepares 703 a short message so that the SI change indication is not set i.e. is 0, but those information elements which are associated with those subgroups, which will be affected by the change, are set e.g. to 1. The other information elements associated with other subgroups are not set i.e. have the value 0. This means that the UEs of the affected subgroups will toggle the SI change bit to 1 and other UEs maintain that indication as not set (0).

It should be noted that similar result would be achieved if the SI change indication is set i.e. is 1, but those information elements which are associated with those subgroups, which will be affected by the change, are not set. The other information elements associated with other subgroups are set to 1. Due to the nature of the swapping operation (XOR) the end results are the same than the first option above. However, the first option enables legacy UEs, which does not have the ability to differentiate subgroup related SI changes, detect system information changes because such UEs might only examine the value of the SI change indication and detect that changes have occurred.

When the network element has prepared the short message, the network element sends 704 the short message as the paging downlink control information (DCI).

On the other hand, if the examination at 702 reveals that the changes affect all subgroups, the network element prepares 705 the short message so that the SI change indication is set i.e. is 1 and those information elements which are associated with the subgroups are not set i.e. have the value 1. This means that all UEs monitoring and receiving the short message will take the modified properties in use.

In accordance with an embodiment, the network element may also modify the value of the information element etwsAndCmasIndication to a value which indicates whether ETWS primary notification and/or an ETWS secondary notification and/or a CMAS notification is/are on.

In the following, examples of assignment of the subgroups will be described. The subgroups corresponding to each bit in the short message may be hard coded in the specifications or be assigned by the gNB. The assignment may either be by allowing the gNB to assign an ID for different sub cohorts of UEs pre-defined in specifications (listed on SIB1, for example) or allowing the gNB to create dynamic indication via RRC (UE assignments). As the needs of different networks can differ, the network assignment option may be more flexible.

Two potential examples of assignments are shown below in terms of ASN.1:

In the first ASN.1 example more than one feature can be assigned to a bit.

SubgroupAssignedForBitX ::= SEQUENCE {
UAV
ENUMERATED {true} OPTIONAL,
V2X
ENUMERATED {true} OPTIONAL,
. . .,
potentialRel-18Feature
ENUMERATED {true} OPTIONAL
}

In the second ASN.1 example only a single feature can be assigned to a bit.

SubgroupAssignedForBitX ::= CHOICE {
UAV
NULL,
V2X
NULL,
. . .,
potentialRel-18Feature
NULL,
}

In another embodiment, the gNB can also use RRC temporary indication—for example via an alert sent via RRC—for some users, indicating that specifically for the next SI modification period they should toggle the first bit, regardless of group assignments.

It should be noted that in these examples the second bit i.e. Bit 2 is independent of the rules presented in this specification, as it may be used for emergency alerts, all UEs should have a common understanding of the usage of Bit 2.

A link between groups and SI may be explained as follows. When the groups are defined, the mapping between each group and specific SIBs to be re-aquired can also be defined. This can be done in specification or via signalling or as a mix by only indicating the group in signaling. For example, if the NTN group is defined it can be implicitly known that the relevant SIB is the NTN SIB.

Next, a possible use of spare bits in DCI are explained, in accordance with an embodiment. If the spare bits in the short message are insufficient or unavailable there are 6 to 8 additional bits available in the paging DCI, which can also be utilized for the purpose of the signaling.

In accordance with an embodiment, the following information is transmitted by means of the DCI format 1_0 with CRC scrambled by P-RNTI:
Short Messages Indicator—2 bits;
Short Messages—8 bits;

$$Frequency domain resource assignment ⌈ {log}_{2} ( {N}_{RB}^{DL , BWP} ( {N}_{RB}^{DL , BWP} + 1 ) / 2 ⌉ - bits ,$$

in which

$${N}_{R B}^{DL , BWP}$$

is the size of CORESET 0. If only the short message is carried, this bit field is reserved.
Time domain resource assignment—4 bits. If only the short message is carried, this bit field is reserved.
VRB-to-PRB mapping—1 bit. If only the short message is carried, this bit field is reserved.
Modulation and coding scheme—5 bits. If only the short message is carried, this bit field is reserved.
TB scaling—2 bit. If only the short message is carried, this bit field is reserved.
Reserved bits—8 bits for operation in a cell with shared spectrum channel access, otherwise 6 bits.

The procedures presented above may be several advantages. The procedure of legacy UEs is not disturbed, nor takes any loss from the new indication dedicated for some users in the network, quite the opposite they benefit from it because, inter alia, no new signalling framework is introduced for broadcast messages (no additional overhead), legacy UEs are prevented to waste power reacquiring system information whose modifications only concerns more modern UEs (or UEs with different capabilities), and UEs can be subgrouped in different wide-groups of users, minimizing the need for UE dedicated messages for more personalized indication of system information concerning specific features.

The above transmissions from the network element may be carried out as broadcast transmissions to all UEs attached in the cell(s)/beam(s).

The method and the embodiments related thereto may be implemented in an apparatus implementing a user equipment (UE). The apparatus may comprise at least one processor and at least one memory, said at least one memory stored with computer program code thereon, the at least one memory and the computer program code configured to, with the at least one processor, cause the apparatus at least to perform: store one or more restrictions, in addition to a timer, for limiting the UE to send on-demand System Information Block (SIB) requests regarding Tracking Reference Signal/Channel State Information Reference Signal (TRS/CSI-RS) configurations for Radio Resource Control (RRC) Idle/Inactive UE mode; check that said one or more restrictions are fulfilled; send an on-demand SIB request regarding TRS/CSI-RS configurations for RRC Idle/Inactive UE mode to a network element; and receive a TRS/CSI-RS configuration SIB from the network element.

Such an apparatus may likewise comprise: means for storing one or more restrictions, in addition to a timer, for limiting the UE to send on-demand System Information Block (SIB) requests regarding Tracking Reference Signal/Channel State Information Reference Signal (TRS/CSI-RS) configurations for Radio Resource Control (RRC) Idle/Inactive UE mode; means for checking that said one or more restrictions are fulfilled; means for sending an on-demand SIB request regarding TRS/CSI-RS configurations for RRC Idle/Inactive UE mode to a network element; and means for receiving a TRS/CSI-RS configuration SIB from the network element.

The method and the embodiments related thereto may also be implemented in an apparatus implementing an access point or a base station of a radio access network, such as an eNB or a gNB. An apparatus, such as a gNB, according to an aspect comprises means for receiving an on-demand System Information Block (SIB) request regarding Tracking Reference Signal/Channel State Information Reference Signal (TRS/CSI-RS) configurations from a user equipment (UE) in Radio Resource Control (RRC) Idle/Inactive mode; and means for sending TRS/CSI-RS configuration SIB to the UE in response to affirming that the UE has been provided with one or more restrictions, in addition to a timer, for limiting the UE to send on-demand SIB requests regarding TRS/CSI-RS configurations for RRC Idle/Inactive UE.

An apparatus, such as an access point or a base station of a radio access network, e.g. an eNB or a gNB, according to a further aspect comprises at least one processor and at least one memory, said at least one memory stored with computer program code thereon, the at least one memory and the computer program code configured to, with the at least one processor, cause the apparatus at least to perform: receive an on-demand System Information Block (SIB) request regarding Tracking Reference Signal/Channel State Information Reference Signal (TRS/CSI-RS) configurations from a user equipment (UE) in Radio Resource Control (RRC) Idle/Inactive UE mode; and send TRS/CSI-RS configuration SIB to the UE in response to affirming that the UE has been provided with one or more restrictions, in addition to a timer, for limiting the UE to send on-demand SIB requests regarding TRS/CSI-RS configurations for RRC Idle/Inactive UE.

Such apparatuses may comprise e.g. the functional units disclosed in any of the FIGS. 1-3 for implementing the embodiments.

A further aspect relates to a computer program product, stored on a non-transitory memory medium, comprising computer program code, which when executed by at least one processor, causes an apparatus at least to perform the above operations.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1.-16. (canceled)

17. A user equipment comprising:
at least one processor; and
at least one memory comprising computer-executable instructions that, when executed by the at least one processor, cause the user equipment to:
receive from, a network, a message comprising: a system information modification change indication and subgroup specific indication in a short message of a paging downlink control information;
determine, from the short message, subgroup configurations and mapping to system information blocks (SIBs);
determine, from the short message, subgroups the user equipment belongs to, wherein the subgroups comprise:
requested features by the user equipment,
supported features by the user equipment,
subscription types of the user equipment,
3GPP releases supported by the user equipment,
public land mobile networks, and
temporary indication via a radio resource control (RRC) for the user equipment;
obtaining, from the short message, information regarding the subgroups corresponding system information blocks (SIBs);
based on the system information modification change indication, monitor for an additional short message of the paging downlink control information for system information change indication;
receive the additional short message;
decode a content of the additional short message;
examine system information modification change indication from the content;
determine whether the system information modification change indication indicates that a system information is modified for a specific subgroup of the subgroups;
when the system information modification change indication indicates that the system information is modified for the specific subgroup of the subgroups, acquire at least one SIB for the specific subgroup; and
when the system information modification change indication does not indicate that the system information is modified for the specific subgroup of the subgroups, acquire at least one SIB according a legacy procedure.

18. The user equipment according to claim 17, wherein the computer-executable instructions further cause the user equipment to:
adjust a value of the system information modification change indication by:
inverting the value of the system information modification change indication, when the subgroup specific indication is set.

19. The user equipment according to claim 17, wherein the computer-executable instructions further cause the user equipment to:
adjusting a value of the system information modification change indication by:
maintaining the value of the system information modification change indication when the subgroup specific indication is not set.

20. The user equipment according to claim 19, wherein the computer-executable instructions further cause the user equipment to:
determining, based on the system information modification change indication, whether to acquire from the network:
only one subgroup SIBS,
one or more SIBs, or
all broadcasted SIBS detected by the user equipment.

21. The user equipment according to claim 17, wherein the computer-executable instructions further cause the user equipment to:
based on the additional short message, determine to acquire from the network one or more SIBs that are not subgroup specific.

22. The user equipment according to claim 17, wherein the computer-executable instructions further cause the user equipment to:
obtain information regarding the subgroups and their assignment to the one or more subgroup specific indication and corresponding SIBs.

23. The user equipment according to claim 22, wherein the information regarding the subgroups and their assignment to the subgroup specific indication is defined in a specification or assigned by the network.

24. The user equipment according to claim 17, wherein the system information modification change indication and the subgroup specific indication in the short message includes an indication that a change of one or more system information parameters of the network is for a user equipment of a subset of the subgroups.

25. The user equipment according to claim 17, wherein the system information modification change indication and the subgroup specific indication in the short message includes an indication that a change of one or more system information parameters of the network is for a user equipment irrespective of a subgroup.

26. A system comprising:
a user equipment comprising:
at least one processor; and
at least one memory comprising computer-executable instructions that, when executed by the at least one processor, cause the user equipment to:
receive from, a network, a message comprising: a system information modification change indication and subgroup specific indication in a short message of a paging downlink control information;
determine, from the short message, subgroup configurations and mapping to system information blocks (SIBs);
determine, from the short message, subgroups the user equipment belongs to, wherein the subgroups comprise:
requested features by the user equipment,
supported features by the user equipment,
subscription types of the user equipment,
3GPP releases supported by the user equipment,
public land mobile networks, and
temporary indication via a radio resource control (RRC) for the user equipment;
obtaining, from the short message, information regarding the subgroups corresponding system information blocks (SIBs);
based on the system information modification change indication, monitor for an additional short message of the paging downlink control information for system information change indication;
receive the additional short message;
decode a content of the additional short message;
examine system information modification change indication from the content;
determine whether the system information modification change indication indicates that a system information is modified for a specific subgroup of the subgroups;
when the system information modification change indication indicates that the system information is modified for the specific subgroup of the subgroups, acquire at least one SIB for the specific subgroup; and
when the system information modification change indication does not indicate that the system information is modified for the specific subgroup of the subgroups, acquire at least one SIB according a legacy procedure.

27. The system according to claim 26, wherein the computer-executable instructions further cause the user equipment to:
adjust a value of the system information modification change indication by:
inverting the value of the system information modification change indication, when the subgroup specific indication is set.

28. The system according to claim 26, wherein the computer-executable instructions further cause the user equipment to:
adjusting a value of the system information modification change indication by:
maintaining the value of the system information modification change indication when the subgroup specific indication is not set.

29. The system according to claim 28, wherein the computer-executable instructions further cause the user equipment to:
determining, based on the system information modification change indication, whether to acquire from the network:
only one subgroup SIBS,
one or more SIBs, or
all broadcasted SIBS detected by the user equipment.

30. The system according to claim 26, wherein the computer-executable instructions further cause the user equipment to:
based on the additional short message, determine to acquire from the network one or more SIBs that are not subgroup specific.

31. The system according to claim 26, wherein the computer-executable instructions further cause the user equipment to:
obtain information regarding the subgroups and their assignment to the subgroup specific indication and corresponding SIBs.

32. The system according to claim 31, wherein the information regarding the subgroups and their assignment to the subgroup specific indication is defined in a specification or assigned by the network.

33. The system according to claim 26, wherein the system information modification change indication and the subgroup specific indication in the short message includes an indication that a change of one or more system information parameters of the network is for a user equipment of a subset of the subgroups.

34. The system according to claim 26, wherein the system information modification change indication and the subgroup specific indication in the short message includes an indication that a change of one or more system information parameters of the network is for a user equipment irrespective of a subgroup.

35. A method comprising:
receiving, by a user equipment (UE) from, a network, a message comprising: a system information modification change indication and subgroup specific indication in a short message of a paging downlink control information;
determining, from the short message, subgroup configurations and mapping to system information blocks (SIBs);
determining, from the short message, subgroups the UE belongs to, wherein the subgroups comprise:
requested features by the UE,
supported features by the UE,
subscription types of the UE,
3GPP releases supported by the UE,
public land mobile networks, and
temporary indication via a radio resource control (RRC) for the UE;
obtaining, from the short message, information regarding the subgroups corresponding system information blocks (SIBs);
based on the system information modification change indication, monitoring for an additional short message of the paging downlink control information for system information change indication;
receiving the additional short message;
decoding a content of the additional short message;
examining system information modification change indication from the content;
determining whether the system information modification change indication indicates that a system information is modified for a specific subgroup of the subgroups;
when the system information modification change indication indicates that the system information is modified for the specific subgroup of the subgroups, acquiring at least one SIB for the specific subgroup; and
when the system information modification change indication does not indicate that the system information is modified for the specific subgroup of the subgroups, acquiring at least one SIB according a legacy procedure.

36. The method according to claim 35, wherein the system information modification change indication and the subgroup specific indication in the short message includes an indication that a change of one or more system information parameters of the network is for a UE of a subset of the subgroups or for a UE irrespective of a subgroup.
